(19) United States
(12) Patent Application Publication
(10) Pub. No.: US 2012/0272325 A1
(43) Pub. Date: Oct. 25, 2012

(54) DIGITAL CONTENT MANAGEMENT SYSTEM AND METHODS

(75) Inventors: Steve A. Stone, Sammamish, WA (US); Carlo Estrada, Sammamish, WA (US); Jeffrey S. Lill, Sammamish, WA (US)

(73) Assignee: INFOFLOWS CORPORATION, Sammamish, WA (US)

(21) Appl. No.: 13/276,189

(22) Filed: Oct. 18, 2011

Related U.S. Application Data
(63) Continuation of application No. 12/185,032, filed on Aug. 1, 2008.
(60) Provisional application No. 60/953,965, filed on Aug. 3, 2007.

(51) Int. Cl. G06F 21/24

(52) U.S. Cl. 726/26

(57) ABSTRACT

Systems and methods for locating network sites using a target digital object in a networked environment are presented. In operation, a request to locate network sites using the target digital object is received. In response to the request, identification information corresponding to the target digital object is obtained. Content of a plurality of network sites on a network is also obtained. For each network site of the obtained plurality of network sites, a determination is made as to whether a digital object on the network site matches the target digital object according to the identification information corresponding to the target digital object. A report indicating the network sites that include a digital object that matches the target digital object is then generated and returned in response to the request.

### CROSS-REFERENCE TO RELATED APPLICATION

This application is a continuation of U.S. patent application Ser. No. 12/185,032, filed Aug. 1, 2008 which claims the benefit of U.S. Provisional Application No. 60/953,965, filed Aug. 3, 2007, the entire disclosures of which are incorporated by reference herein.

### BACKGROUND

It is estimated that each year more than 1 trillion valuable enterprise digital objects are generated worldwide, many of which include little or no information (metadata) that identifies the owner. These valuable digital objects include, but are not limited to, images, audio content, video content, text, collections and/or combinations of the aforementioned, executable content, and the like. For convenience, these digital objects will be referred to generically hereafter as digital content. Indeed, the value of digital content for the year 2006 was over 50 billion dollars as estimated by the music, entertainment, news media, and stock image industries. Unfortunately, during that same year it was further estimated that the value of improperly licensed content exceeded 11 billion dollars.

It is well known that digital content can be easily and repeatedly duplicated with full fidelity at almost no cost. Hence, there are those that nefariously duplicate digital content and profit therefrom. Additionally, there are those that unknowingly use digital content without an appropriate license. For the digital content owner, enforcing rights to digital content has been extraordinarily difficult due to a variety of factors, not the least of which is finding those that illegally make use of digital content.

Another issue related to the unlicensed use of digital content is the growing problem of “orphan works.” An orphan work is, at its simplest level, a physical and/or digital work for which the owner can not be found or identified and, further, that it can not be proved that the work has been abandoned to the public domain. In short, a business, user, or group cannot always determine to whom a work belongs or if the work is in the public domain for all to use. Indeed, in January of 2006, the U.S. Copyright Office recommended that the orphan works issue be addressed by an amendment to current copyright law and has made a call for the industry to develop solutions to better track and identify digital content, given that current methods are inadequate.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram showing an illustrative network environment suitable for providing digital content management services as described herein;

FIG. 2 is a block diagram showing logical components of an illustrative digital content management host suitable for implementing various aspects of managing registration, identification, and clearance of digital content;

FIG. 3 depicts a flow diagram showing an illustrative routine for registering digital content with a digital content management host;

FIG. 4 depicts a flow diagram of an illustrative routine for locating registered digital content on a network;

FIG. 5 depicts a flow diagram of an illustrative subroutine for processing digital objects on a network site to determine whether any of the digital objects match a target digital object;

FIG. 6 depicts a flow diagram of an illustrative routine for locating unregistered digital content on a network;

FIG. 7 depicts a flow diagram showing an illustrative routine for conducting a clearance search of digital content; and

FIG. 8 depicts a flow diagram showing an illustrative routine, as implemented from the perspective of a content owner, for managing the rights of digital content using a digital content management host.

### DETAILED DESCRIPTION

For purposes of clearly understanding the subject matter described herein, the following definitions are set forth:

Digital Object: a digital object is digital content and refers to a digitally encoded item. By way of example, but not limitation, a digital object may be a music file, a digital image, a video or audio/visual file, a text file, an executable module, and the like.

Digital Handle: a digital handle or, more simply, “handle,” is a unique identifier corresponding to a specific digital object. Digital handles may be derived from the subject matter of the corresponding digital object. A digital object for which a digital handle has been generated is said to be “handlized.” A digital handle is typically, though not exclusively, used by the management system disclosed herein as a general reference to the digital object and may be further used as an index for information corresponding to the digital object in a data store.

Digital Content Management Architecture: the digital content management architecture corresponds to an organization of services, servers, and data stores for managing the identification, tracking, and clearance of digital content in a network environment.

Digital Fingerprint: a digital fingerprint is the product of a process that locates and extracts identifying characteristics of a digital object. The output of a digital fingerprint is unique to the source digital object and, thus, may be used to identify the digital object. Generating a digital fingerprint is well known to those skilled in the art.

Digital Content: as mentioned above, digital content refers, generically, to digital objects and may refer to one or more digital objects.

Digital Watermark: a digital watermark is information added to a digital object to facilitate identification of the digital object. As those skilled in the art will appreciate, a digital watermark may be hidden (undetectable) or unhidden (overt or detectable). A hidden watermark is typically undetectable by a user and does not interfere with the intended use of the digital object. On the other hand, an unhidden watermark is placed on the digital object such that the object can be evaluated, but the watermark generally interferes with the intended use.

As will be described in more detail below, according to aspects of the disclosed subject matter, content owners and distributors can mark, track, and verify the usage of digital content over a network such as the Internet. This can be done for both registered and unregistered digital content. Additionally, content consumers (i.e., those that make use of digital content) can identify the content owners of digital content and, after identifying the owner, use the identification to validate that the digital object is used according to appropriate license and/or secure the rights to use the digital content.

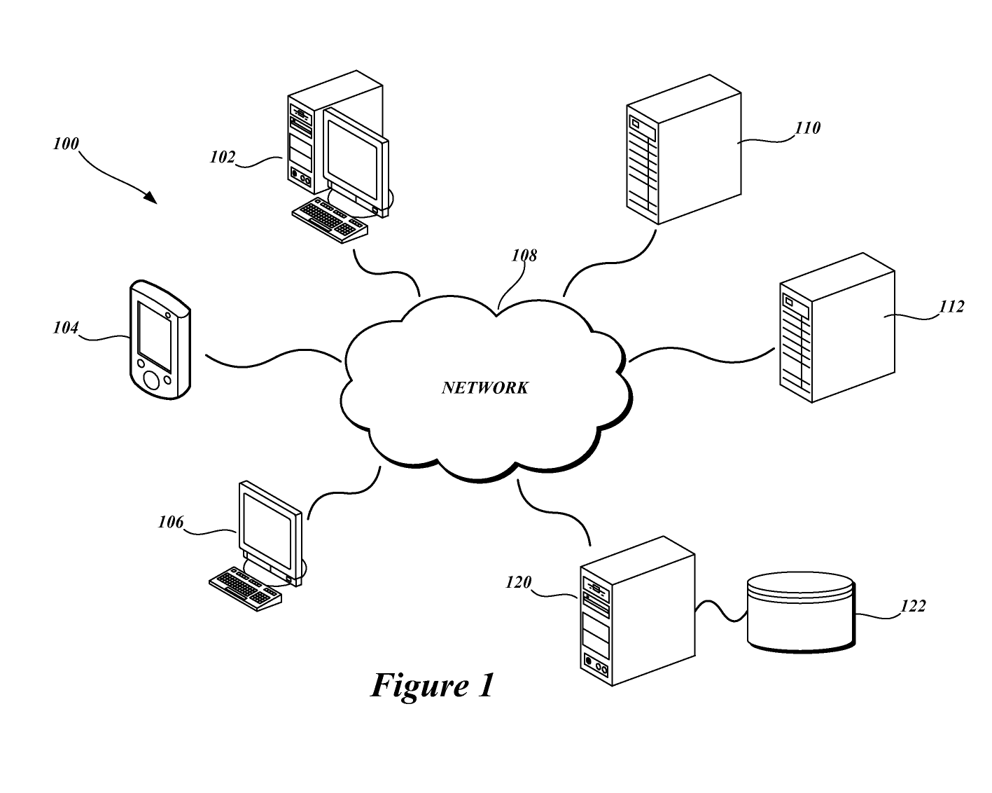

Turning now to FIG. 1, this figure depicts a block diagram showing an illustrative network environment 100 suitable for providing digital content management services as described below. The illustrative networked environment 100 includes one or more client computing devices, such as client devices 102-106, by which users can connect to a network 108. Several of the users connected to the network 108 may include content owners that take advantage of the digital content management services disclosed herein. In one embodiment, the network 108 corresponds to the Internet, though the disclosed subject matter is not limited to the Internet. Indeed, embodiments of the disclosed subject matter may be implemented on local area networks (LANs) and intranets as well as on wide area networks (WANs), the world-wide web (WWW), and the like as well as combinations thereof.

Client devices 102-106 may include, by way of illustration and not limitation, personal computers, laptop and/or tablet computers, personal digital assistants (PDAs), wireless telephones, PDA/wireless phone hybrid devices, portable media players, and the like. These devices may connect to the network 108 via a wired connection, a wireless connection, or through an intermediary device such as a portable media player connecting to the network by way of a personal computer's wired network connection.

Also included in the networked environment 100 are one or more host servers, such as servers 110 and 112 that host content on the network 108. As those skilled in the art will appreciate, host servers provide services and host content accessible to others on the network 108. For example, a user using client device 102 may direct a browser to access and retrieve content from host server 110. The content hosted by host servers 110 and 112 on the network 108 may include digital content that is owned by others not directly associated with the host server. Moreover, some of the content owned by others that is used by the host servers 110 and 112 may be used outside of license or permission of the content owner. As discussed below, aspects of the disclosed subject matter are directed at locating uses of digital content such that a determination can be made as to whether the digital content is used within licensed limits.

The host servers may include, by way of illustration and not limitation, personal computers, laptop and/or tablet computers, mini- and/or mainframe computers, workstations, and the like. Host servers may be comprised of a single computing device or of a plurality of cooperative computing devices. As with client devices, host servers may connect to the network 108 via a wired connection, a wireless connection, or through an intermediary device.

To assist content owners in locating and tracking the use of their digital content, also included in the illustrated networked environment 100 is a digital content management host 120. As will be discussed below, the digital content management host 120 provides location and clearance services for digital content owners. Associated with the digital content management host 120 is a digital object registry 122 that stores information used in locating and providing clearance for registered digital content.

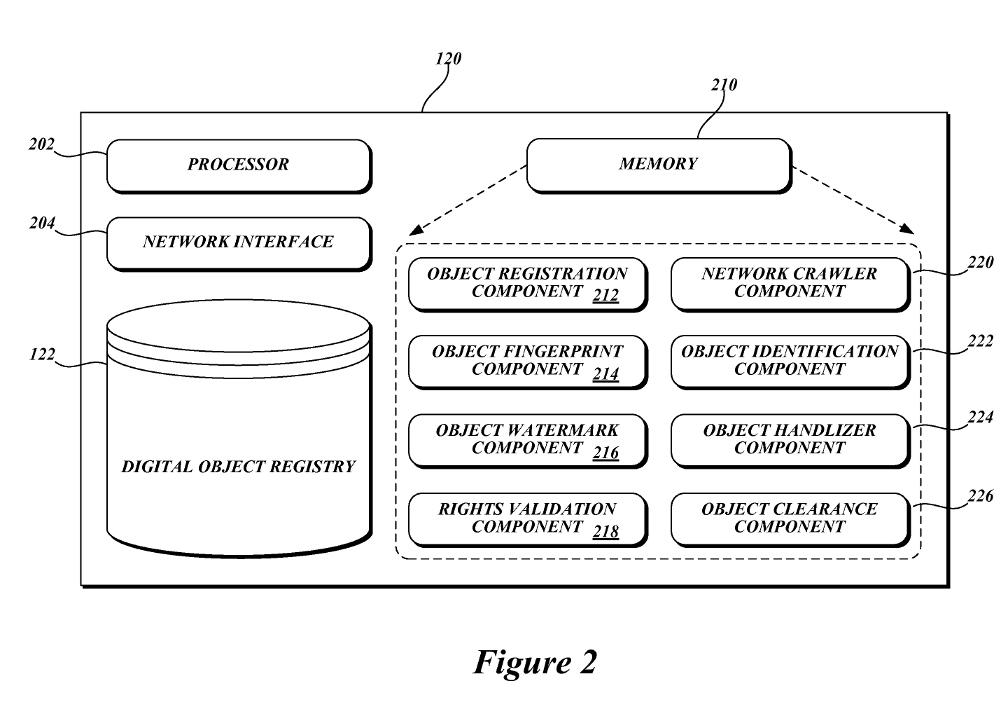

Regarding the digital content management host 120, FIG. 2 is a block diagram showing logical components of an illustrative digital content management host suitable for implementing various aspects for managing the registration of digital content as well as providing services regarding location and clearance of digital content. The digital content management host 120 includes a processor 202, a network interface 204, and a memory 210. As those skilled in the art will appreciate, the processor 202 executes computer-executable instructions from memory 210 that carry out its various functions for registration, location, and clearance. Also illustrated as part of the digital content management host 120 is the digital object registry 122. While illustrated as being part of the digital content management host 120, it should be appreciated that the digital object registry 122 may be external to the digital content management host. Accordingly, the illustrated embodiment should be viewed as one of many embodiments of a digital content management host 120 and should not be construed as limiting upon the disclosed subject matter.

As those skilled in the art will appreciate, the memory 210 may be comprised of, without limitation, read-only memory (ROM), random-access memory (RAM) that is typically read/write memory, flash memory, persistent data storage, and the like. Further, the memory 210 stores the computer-executable instructions that are executed by the processor 202 for providing registration, location, and clearance services with regard to digital content. Indeed, certain functions are logically identified as executable modules within the memory 210, including: an object registration component 212; an object fingerprint component 214; an object watermark component 216; a rights validation component 218; a network crawler component 220; an object identification component 222; an object handlizer component 224; and an object clearance component 226. Of course, it should be appreciated that these are logical, not necessarily actual, components and may be actually implemented in any number of combinations and forms. Further still, it should be appreciated that the digital content management host 120 may include other components that are not described herein for simplicity purposes.

The object registration component 212 is used to interface with a digital content owner to provide registration services of digital content. Registered digital content corresponds to content that has been identified to the digital content management host 120 such that the host can generate and record certain information regarding the digital content, which is stored in the digital object registry 122, and further returns registration information to the content owner regarding the digital content. In one embodiment, a “handle,” which is a unique identifier of the registered digital content, is returned to the content owner. Registered digital content may be marked, or more particularly watermarked, for assistance in recognizing the registered digital content on the network. The object registration component 212 makes use of various other components to perform the registration, including fingerprinting, watermarking, and handlizing the digital content.

As part of the registration process, the object registration component 212 may be further configured to obtain license and rights information from the content owner. This information corresponds to licenses already granted, permitted uses, as well as information for granting rights and/or licenses to use the registered content. Additionally, the object registration component 212 may generate metadata for the registered digital object. Metadata for registered content may include (but is not limited to) the handle to the digital content, pointers to information regarding use rights of the digital content, information corresponding to the content owner, information pointing to the content owner's catalogue of digital content, and the like. The metadata may be stored in a non-data area of the digital content or, alternatively, in a metadata file associated with the digital content.

The object fingerprint component 214 generates a “fingerprint” for a given digital object. Just as with fingerprints of people, a digital object fingerprint corresponds to certain characteristics of a digital object that, in combination (or sub-combination), uniquely identify the digital object. Accordingly, the object fingerprint component 214 identifies and extracts identifying characteristics of the digital object and generates the fingerprint therefrom. When a digital object is registered, the digital object's fingerprint is stored in the registration information corresponding to the object in the digital object registry 122. Techniques for generating fingerprints for a digital object are known in the art and are therefore not described in this document.

The object watermark component 216 is used to mark a digital object with identifying marks/characteristics to facilitate identification of the object. As those skilled in the art will appreciate, watermarking adds information to a digital object such that the watermark can be detected by particular processes and/or hardware. As mentioned above, a hidden watermark is not typically perceived by humans while an over or unhidden watermark will likely be apparent to the user. A watermark may be made before or after a digital object is fingerprinted. Generally speaking, watermarking a digital object makes it more readily identifiable than merely generating a fingerprint. Further still, the watermark may include encoded information such that, when extracted, the watermark or a portion thereof can be used as an index into the digital object registry 122 to identify object and the object owner.

The rights validation component 218 is used to validate whether a host server (and/or host service) is using a digital object in compliance with a use license. Use license and rights information may be stored in the digital object registry 122 (or related to a registered digital object in the digital object registry) such that upon locating a digital object, the digital content management host 120 can determine whether the use of the digital object is in compliance with its license. The rights validation component 218 may further be configured to facilitate or conduct transactions with those sites that are making use of registered digital content outside of current licenses.

The network crawler component 220, as the name suggests, performs a network search, referred to as network crawling, looking for digital content. Upon encountering digital content at a network site, the network crawler component 220 invokes the object identification component 222 to determine whether the encountered object is one for which the digital content management host 120 is searching. The digital content management host 120 may crawl the network searching for uses of one or more specific digital objects or for registered digital objects in general. When a sought-for digital object is located, the network crawler component will typically annotate the location of the digital object and continue with its crawling. The network crawler component 222 may be directed to particular areas of a network, or perform general network crawling. A report or log of use of a digital object may be provided to a content owner as a result of the crawling.

Regarding the report/log that is created for a content owner, the report may include (but is not limited to) information as to where (i.e., the network sites) the digital object was found, the length of time that the digital object has been in use at each site, the number of instances the digital object was used at a particular location, the manner or type of use of the digital object, whether the digital object has been modified or the metadata and/or watermarks have been removed, links to the rights associated with the digital object, and the like. Further, in conjunction with the rights validation component 218, the report may include an indication as to whether the use of the digital object falls within licensed rights/uses. As those skilled in the art will appreciate, the report (or log) can play a critical role in enabling a content owner to control and manage the digital object on the network.

With reference to both the generated report of the network crawler component 222 and the rights validation component 218, in one embodiment the rights validation component may be configured maintain a data store (not shown) of information corresponding to the access rights of one or more content owners and further configured to obtain the report generated by the network crawler component and automatically provide an analysis of whether or not one or more digital objects are used within licenses, automatically contact the content users with regard to licensing the digital content, provide details and/or recommendations to a content owner regarding potential licensing terms for presentation to current content uses, and the like. Further, the data store may be a general data store (or database) maintained by the digital content management host 120 for one or more content owners or, alternatively, may correspond to a content owner-specific data store. These data stores may be located with the digital content management host 120 or at a remote location, including one hosted by a content owner.

The object handlizer component 224, typically as part of a registration process, generates a handle for the digital object which can be used as a general identifier for the digital object. In various embodiments, the handle (or a portion thereof) may be used as an index in the digital object registry for that object. Frequently, the handle of the digital object is returned to the content owner as part of the registration information.

The object clearance component 226 is a component with which people, businesses, groups, and the like can interface to determine whether a digital object is registered with the digital content management host 120 and, if so, may obtain information as to the identity of the content owner. The object clearance component 226 may utilize various other components including the object identification component 222, the object fingerprint component 214, the digital object registry 122, and the like.

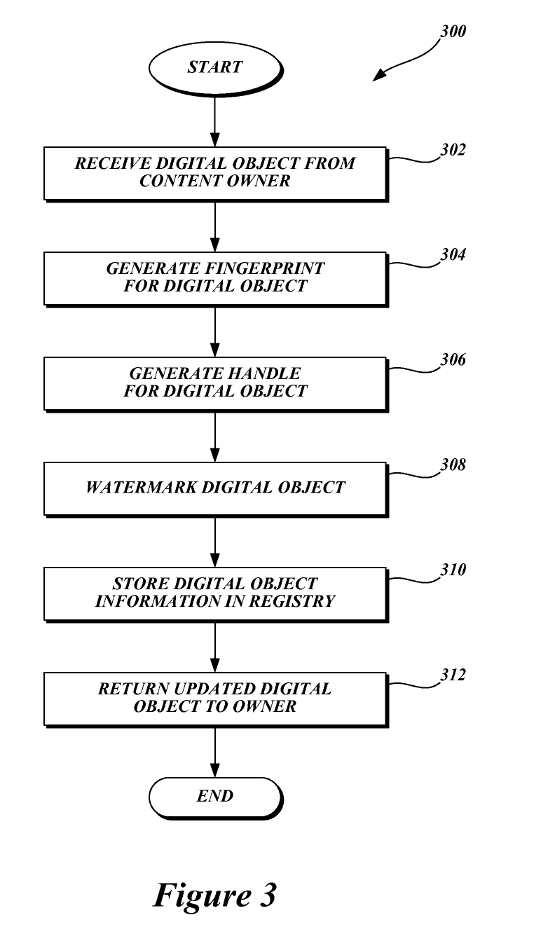

To facilitate location, as well as clearance, of digital objects, content owners can register their digital content with the digital content management host 120. By registering with the host 120, content owners can establish registration information with the host to facilitate location of their content on the network 108. This may be accomplished by obtaining a fingerprint of the digital content as well as embedding digital watermarks within the content that can be used to further facilitate object recognition. Correspondingly, FIG. 3 is a flow diagram showing an illustrative routine 300 for registering digital content with a digital content management host 120. Regarding the routine 300, as well as all other routines described herein, those skilled in the art will appreciate that while various steps are recited in a particular order, the order of the various steps may be modified and/or executed in parallel without departing from the intent thereof.

Regarding routine 300, beginning at block 302, the digital content management host 120 receives a digital object from a content owner accompanied by a request to register the digital object with the host. At block 304, the digital content management host 120 generates a digital fingerprint (by way of the object fingerprint component 214) for the digital object. At block 306, a handle is generated (by way of the object handlizer component 224) for the digital object. As already suggested, the handle is an identifier/record that is generated by the digital content management host 120 to uniquely identify and reference the registered digital object.

At block 308, the digital object is watermarked (by way of the object watermark component 216). In various embodiments, all or some of the information from the handle may be included as subject matter of the digital watermark that is added to the digital object. At block 310, a record corresponding to the digital object is created and information regarding the digital object is stored in the record in the digital object registry 122. By way of illustration, but not limitation, this information may include information identifying the content owner, the watermarked digital object, the watermark information added to the digital object, the digital object's fingerprint, information as to licensed use of the digital object, the digital object's handle, and the like.

After recording the registration information in the digital object registry 122, the updated digital object (with the watermark), as well as the handle to the registration information in the digital object registry, are returned to the content owner and the routine 300 terminates.

While routine 300 of FIG. 3 suggests that all registered digital objects are watermarked, it should be appreciated that while watermarking digital content may facilitate its identification on a network, watermarking is not a necessary aspect of content registration. In an alternative embodiment, digital content is not watermarked and is simply identified by the digital fingerprint of each digital object.

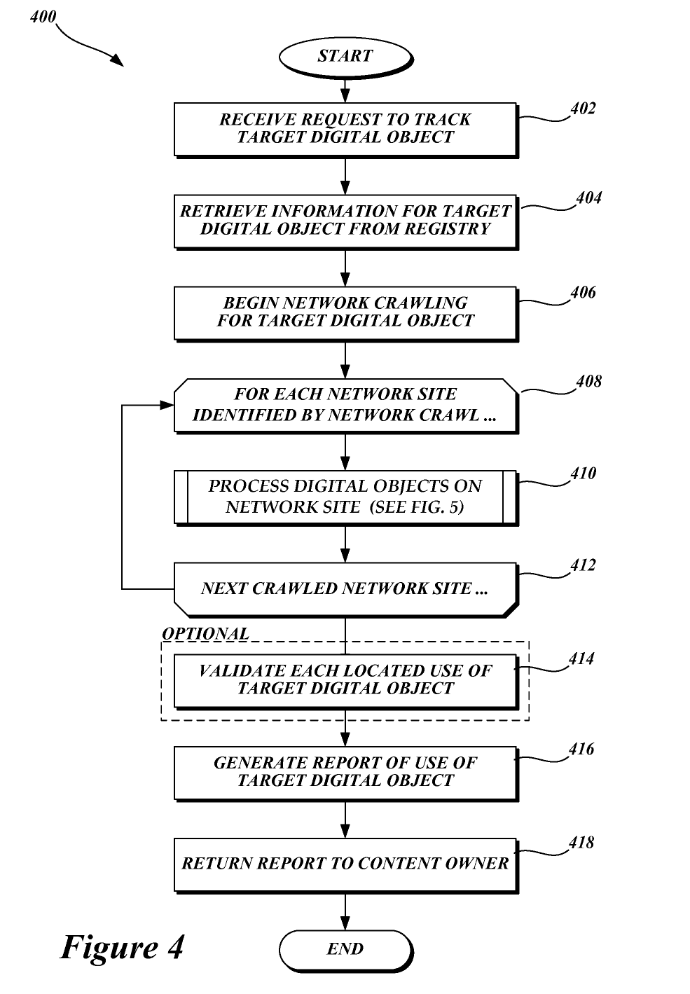

Once a digital object has been registered, the content owner can use the services provided by the digital content management host 120 to locate network uses of a registered digital object. To that end, FIG. 4 depicts a flow diagram of an illustrative routine 400 for locating registered digital content on a network 108.

Beginning at block 402, the digital content management host 120 receives a request from a content owner to locate uses of a target digital object. Typically, the content owner will identify the target digital object by way of the object's handle. At block 404, information regarding the target digital object is retrieved from the digital object registry 122. At block 406, a network crawling process is begun (by way of the network crawler component 220) to “crawl” the network and locate usages of the target digital object. Those skilled in the art will appreciate that the network crawl may be already ongoing and that the action taken in block 406 is to add the target digital object to the list of objects to be tracked in the network crawl.

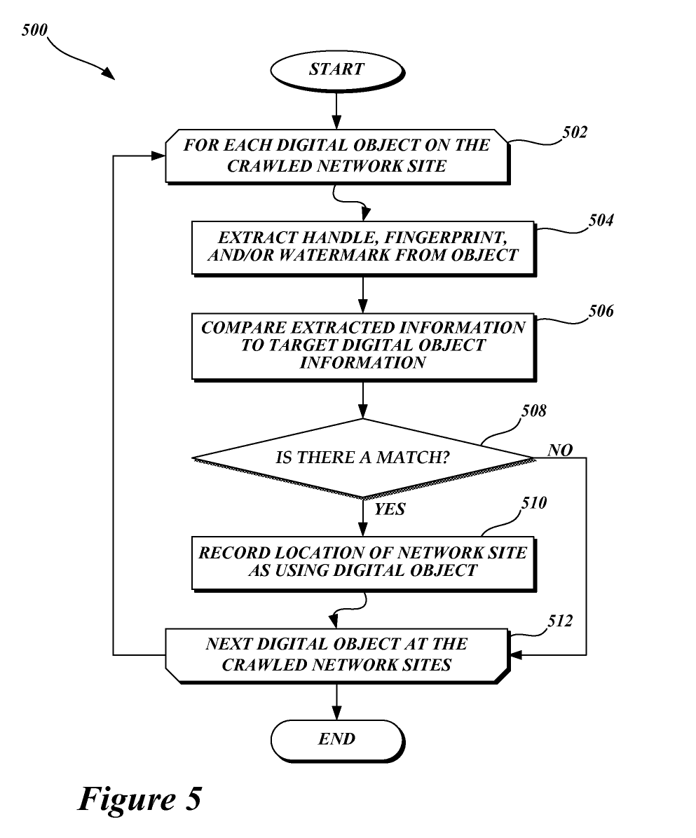

At control block 408, a looping process is begun to iterate through the network sites identified by the network crawl (which may be ongoing). Accordingly, at block 410, the digital content management host 120 processes the digital objects on the currently processed network site looking for a match of the digital object. Processing the digital objects of a network site looking for a match to a target digital object is set forth in FIG. 5.

As mentioned above, FIG. 5 depicts a flow diagram of an illustrative subroutine 500 for processing digital objects on a network site to determine whether any of the digital objects match a target digital object. Beginning at control block 502, a looping process is begun to iterate through the digital objects on the network site being examined. With regard to a current digital object from the currently examined network site, at block 504 a digital handle, fingerprint, and/or watermark is extracted from the current digital object. More particularly, if a handle is available in metadata associated with the current digital object, that handle may be first used to attempt to match it to the target digital object. Failing that, the routine 500 may attempt to identify a watermark in the current digital object so that the watermark may be used to potentially match the current digital object to the target digital object. Finally, a digital fingerprint may be generated from the current digital object for use as identifying information.

Irrespective of the type of identifying information obtained (handle, watermark, or fingerprint), at block 506 the obtained/extracted information identifying the current digital object is compared to corresponding information for the target digital object. At decision block 508, a determination is made as to whether the current digital object is a match to the target digital object based on the previous comparison. If there is a match, at block 510 the network site found using the target digital object is recorded, typically in a log file. Thereafter, or if the current digital object was not a match to the target digital object, the routine 500 proceeds to control block 512.

At control block 512, if there are additional digital objects on the current network site to be processed, the routine 500 returns to control block 502 to process another of the remaining, unprocessed digital objects. However, if all of the digital objects of the current network site have been processed, the routine 500 terminates.

Returning again to FIG. 4, after having processed all digital objects of the current network site, the routine 400 proceeds to end control block 412. At end control block 412, if there are additional network sites to be processed, the routine 400 returns to control block 408 to repeat the process described above. Alternatively, if there are no more network sites to be processed, the routine 400 proceeds to block 414.

It should be appreciated that a network crawl may be ongoing and visit a particular site more than once. Moreover, networks such as the Internet are always expanding. As such, it is often difficult to say that “all” network sites have been examined, and determining when to quit examining network sites for a target digital object may be determined by factors other than an exhaustive search of millions of network locations. As suggested above, the content owner may request that a list of network sites be examined or that a particular area of a network be examined. Other directives are also possible. Accordingly, ending the looping process of examining network sites may be a matter of development design choice and/or content owner request. This is especially important as the digital content management host 120 may charge the content owner for the location services, and may base those charges on the number of network sites examined.

After having “completed” the examination of network sites, at block 414 the digital content management host 120 may optionally validate each located use of the target digital object to ensure that the use complies with permissions granted by the location owner. In one embodiment, the permissions would be located in the digital object registry 122 with the registration information for the target digital object, or found in a related data store. As suggested above, the rights validation component 218 may be optionally configured to obtain the report generated as a result of a network search and automatically provide an analysis to the content owner of whether or the digital object is used within licensed limits, automatically contact the identified users (those using the digital object outside of license) with regard to licensing the digital object, provide details and/or recommendations to the content owner regarding licensing terms for the current uses, and the like.

At block 416, the digital content management host 120 generates a report of the located uses of the target digital object. At block 418, the report is returned to the content owner and the routine 400 terminates.

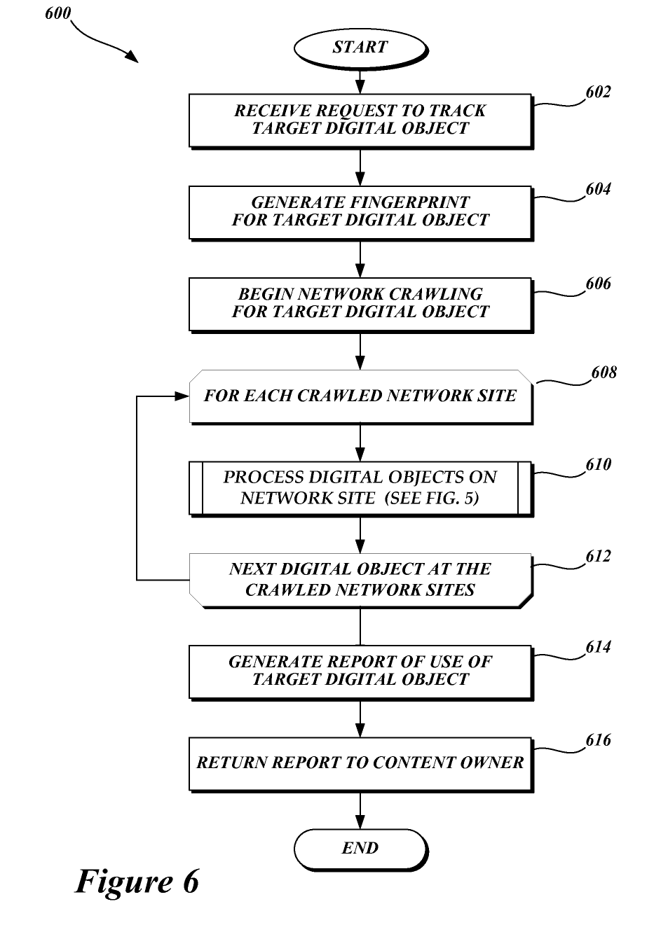

It should be appreciated that a content owner need not register his/her digital content with the digital content management host 120 prior to requesting the location services of the host. To that end, FIG. 6 depicts a flow diagram of an illustrative routine 600 for locating unregistered digital content on a network 108. At block 602, the digital content management host 120 receives a request from a content owner to locate the uses of a target digital object. At block 604, the digital content management host 120 generates a fingerprint for the target digital object for locating other uses.

At block 606 a network crawling process is begun (by way of the network crawler component 220) to “crawl” the network and locate usages of the target digital object. At control block 608, a looping process is begun to iterate through the network sites identified by the network crawl (which may be ongoing). Accordingly, at block 610, the digital content management host 120 processes the digital objects on the currently processed network site looking for a match to the digital object. Processing the digital objects of a network site looking for a match to a target digital object is set forth in the discussion of FIG. 5.

After having processed the digital objects of the current network site, the routine 600 proceeds to end control block 612. At end control block 612, if there are additional network sites to be processed, the routine 600 returns to control block 608 to repeat the process described above. Alternatively, if there are no more network sites to be processed, the routine 600 proceeds to block 614.

At block 614, the digital content management host 120 generates a report of the located uses of the target digital object. At block 616, the report is returned to the content owner and the routine 600 terminates.

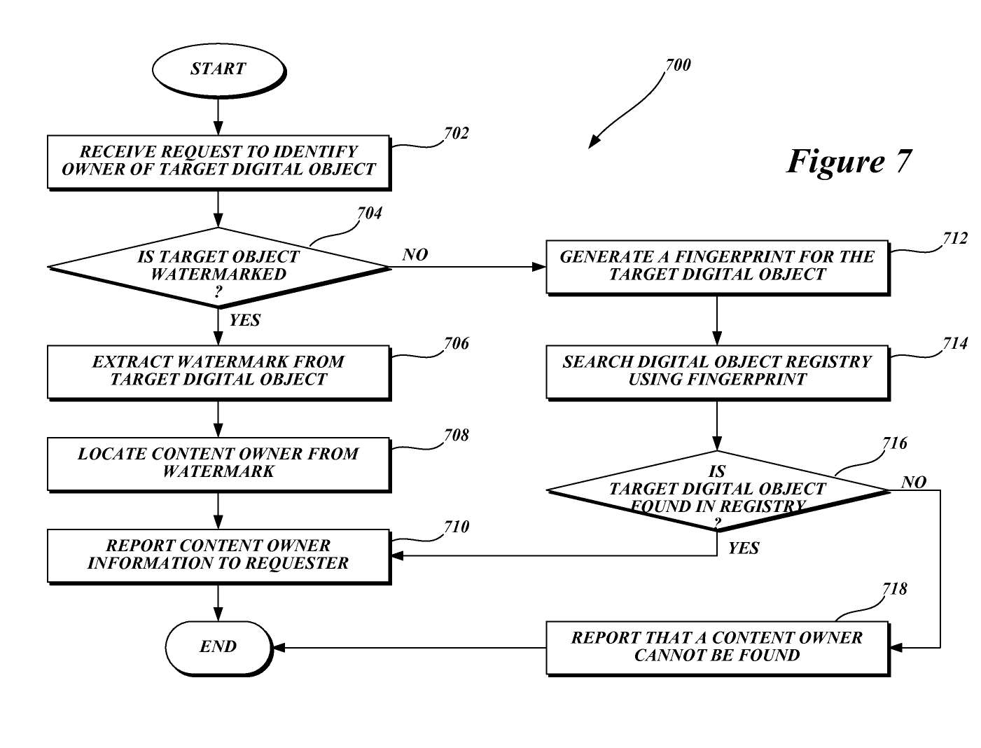

In addition to providing location and license validation services to content owners, the digital content management host 120 also provides clearance services to those who wish to use digital content. Clearance services assist a user/business/group to determine whether the digital content is owned and by whom, or whether the content is dedicated to the public domain. FIG. 7 depicts a flow diagram showing an illustrative routine 700 for conducting a clearance search of digital content on a digital content management host 120.

Beginning at block 702 of FIG. 7, the digital content management host 120 receives a request to identify the owner (i.e., perform a clearance) of a target digital object. As part of receiving the request to identify the content owner of a target digital object, the digital content management host 120 may record (not shown) the clearance request by the requester in a report or log that is maintained by the host. Maintaining a record of the request enables the host to validate or verify that the requester made a clearance request to locate a digital content owner. Indeed, verification may be especially important when the content owner is not found in order to demonstrate a bona fide effort to locate the owner. In addition to maintaining a record of the clearance request, the digital content management host 120 may generate and transmit a verification email to the requester as evidence of the clearance request, or provide some other verification receipt.

At decision block 704, the digital content management host 120 determines whether the target digital object includes a watermark. If the target digital object includes a watermark (which indicates that the target digital object is a registered object), at block 706 the digital content management host 120 extracts the watermark from the object. At block 708, using the extracted watermark, a lookup is performed on the digital object registry 122 to locate the object's information, including the content owner of the digital object. At block 710, the digital content management host 120 reports the information regarding the digital content owner to the requester. In addition to reporting the information regarding the digital content owner to the requester, while not shown, the digital content management host 120 may also provide a facility to contact the digital content owner and purchase rights, or provide a link to a catalog corresponding to the digital objects available from the content owner. Thereafter, the routine 700 terminates.

If, at decision block 704, the target digital object does not include watermark information, the routine 700 proceeds to block 712. At block 712, a fingerprint is generated for the target digital object. Using the fingerprint, at block 714 a search is performed on the registered digital objects found in the digital object registry 122. At decision block 716, a determination is made as to whether the target digital object is found in the digital object registry 122. If the target object is found, the routine 700 proceeds to block 710, where the digital content management host 120 reports the information regarding the digital content owner to the requester, as well as optionally facilitating the purchase of the digital content and/or linking the requester to a catalog of digital content (likely including the target digital object) of the content owner where the requester can obtain the rights to use the digital object. Thereafter, the routine 700 terminates. However, if the target digital object is not found to match a registered digital object in the digital object registry 122, at block 718 the digital content management host 120 reports that no match was found in the registry. Of course, this does not necessarily mean that the requestor is free to use the target digital object, only that the digital content management host 120 was unable to locate the content owner. If, however, in addition to a digital object registry 122, the digital content management host 120 included a public domain registry that included information regarding digital content that is in the public domain, a confirmation that the target digital object is found in that registry would be a strong indication that the requestor is free to use the content.

As an alternative, the digital content management host 120 can also offer alternative content to a requester. For example, if the target digital content is owned by a content owner and the requester is not willing to purchase that content, the digital content management host 120 may offer alternative content that is similar in nature but that is either less expensive or found in the public domain. In one embodiment, to identify similar content, the digital content management host 120 obtains the fingerprint of the target digital object and uses the aspects of the fingerprint to identify other content by matching fingerprint aspects. Of course, a requester may desire to have alternative content for a variety of reasons and the digital content management host 120 would not be limited to presenting such alternative content to those situations where the target digital object is too expensive.

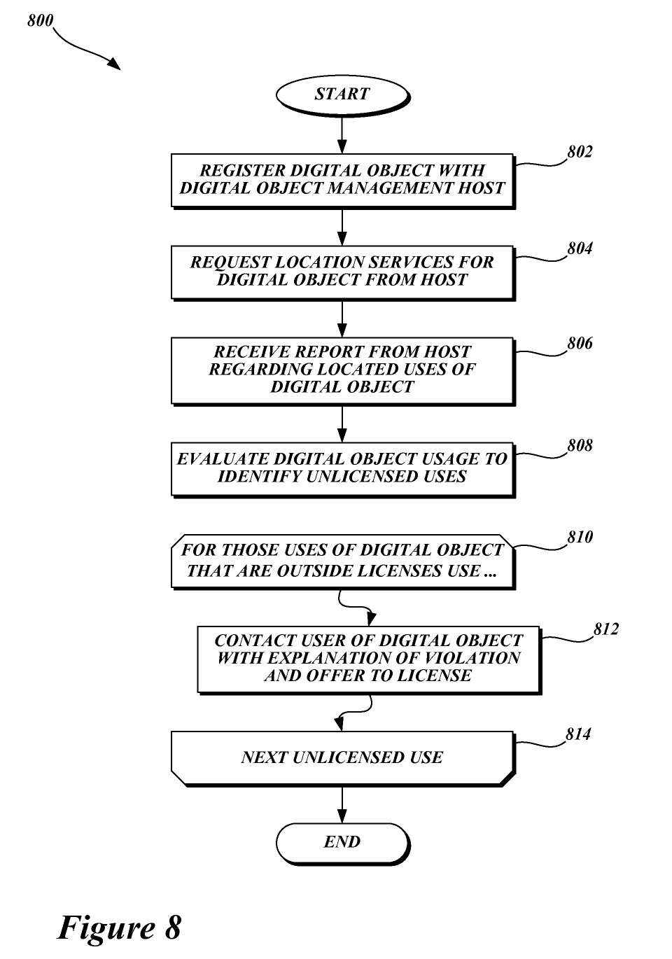

The routines described above are made from the perspective of the digital content management host 120. In contrast to those routines, FIG. 8 depicts a flow diagram showing an illustrative routine 800, as implemented from the perspective of a content owner on a content owner computing device, for managing the rights of digital content using a digital content management host 120.

Beginning at block 802, the content owner registers a digital object with the digital content management host 120. Registering a digital object with the digital content management host 120 is discussed above, and the result is to obtain a handle for the digital object.

At some point after registering the digital object, at block 804 the content owner request use of the location services provided by the digital content management host 120 to locate uses of a target digital object on the network 108. In response to the request, the digital content management host 120 performs the search/crawl and returns a report identifying the located uses of the target digital object. As mentioned above, the report may include information such as the network sites that are using the target digital object, the number of instances that the digital object is used by a network site, the manner in which the digital object is being used, whether the digital object has been modified, the amount of time that the digital object has been used at a particular network site, and the like. At block 808, the report is evaluated to identify any uses that fall outside of currently licensed use.

At control block 810, a loop is begun to iterate through the reported uses that fall outside of licensed rights. Thus, for each instance where the use falls outside of the rights currently granted to use the target digital object, the content owner (via the content owner's computing device) contacts the user of the target digital object with an explanation of the violation as well as an offer (or a request for an offer) to license the digital object for the current use. Of course, this offer will likely reflect the current use, the number of instances of use, the type of use, the length that the site has been using the object, and the like.

At end control block 814, if there are additional sites that are to be contacted, the routine 800 returns to block 810 and proceeds as described above with regard to another unlicensed use of the target digital object. However, after processing all of the unlicensed uses, the routine 800 terminates. Of course, while not illustrated here, those skilled in the art will appreciate that additional processing may occur with regard to conducting the transactions between an unlicensed user and the content owner. However, to simplify the presentation of the routine 800 presented above, those details as well as others, all of which are known in the art, have been omitted.

While the above recited routines may be installed and operational on a digital content management host 120, it is anticipated that the routines may also be embodied on computer-readable media for distribution purposes. Indeed, the computer-readable media may include, by way of illustration and not limitation, optical storage media, removable and fixed magnetic storage media, non-volatile memory storage devices such as flash memory devices, and the like.

While illustrative embodiments have been illustrated and described, it will be appreciated that various changes can be made therein without departing from the spirit and scope of the invention.

The embodiments of the invention in which an exclusive property or privilege is claimed are defined as follows:

1. A method for managing the use of content over a network, comprising:
storing at least one of a source digital fingerprint or a source identifier that corresponds to each of a plurality of items of source content, wherein at least one use of a copy of each source content item is licensable;
determining, by a processor, if another identifier included with an item of content is received from a user indicating at least one particular type of use indicated by the user for the item of content, and has an affirmative correspondence to at least one of the stored source identifiers associated with each source content item;
if the determination of the other identifier is negative, determining if another digital fingerprint determined for the received content item is substantially similar to at least one of the source digital fingerprints associated with each source content item;
determining, by a processor, each license previously provided for a user that corresponds to the received content item based on the affirmative correspondence between at least one of the source identifiers and the other identifier or a substantially similar comparison between the source digital fingerprints and the other digital fingerprint; and
if a license for the user for the at least one particular type of indicated use for the received content item is determined to be unavailable, determining at least one other source content item that is non-identical to the received content item and that is both substantially equivalent to the received content item and available for licensing for at the least one particular type of indicated use by the user, wherein the determination of the at least one other source content item is based on at least the affirmative correspondence.

2. The method of claim 1, further comprising providing the determined equivalent source content item to the user that accepts a license for at least one type of use for the equivalent source content item.

3. The method of claim 1, further comprising displaying information for the user regarding at least one of type of use for at least one license that is available to the user.

4. The method of claim 1, wherein each determined license includes at least one of: a current license for the user for at least one type of use for the received content item; an expired license for the user for at least one type of use for the received content item, wherein further information is provided to the user for renewing at least the expired license; or an absent license for the user for at least one type of use for the received content item.

5. The method of claim 1, wherein the source content item includes at least one of video, picture, executable module, text, or audio recording.

6. The method of claim 1, wherein at least one of the source identifier and the other identifier includes a metadata payload.

7. The method of claim 1, further comprising providing license information in at least one manner, including email.

8. The method of claim 1, further comprising automatically pre-processing at least a portion of received content item stored in at least one location for at least one license for at least one type of use.

9. A network device for managing the use of content over a network, comprising:
a memory for storing data;
a processor for enabling actions based at least in part on the stored data; and
an application that includes components, including:
a first component for enabling the storing of at least one of a source digital fingerprint or a source identifier that corresponds to each of a plurality of items of source content, wherein at least one use of a copy of each source content item is licensable;
a second component for determining if another identifier included with an item of content is received from a user indicating at least one particular type of use indicated by the user for the item of content, and has an affirmative correspondence to at least one of the stored source identifiers associated with each source content item;
a third component for determining if another digital fingerprint determined for the received content item is substantially similar to at least one of the source digital fingerprints associated with each source content item, if the determination of the correspondence of the other identifier to the stored source identifiers is negative;
a fourth component for determining each license previously provided for a user that corresponds to the received content item based on the affirmative correspondence between at least one of the source identifiers and the other identifier or a substantially similar comparison between the source digital fingerprints and the other digital fingerprint;
a fifth component for if a license for the user for the at least one particular type of indicated use for the received content item is unavailable, determining at least one other source content item that is non-identical to the received content item and that is both substantially equivalent to the received content item and available for licensing for the at least one particular type of indicated use by the user, wherein the determination of the at least one other source content item is based on at least the affirmative correspondence; and
a sixth component for enabling the offering of the license for at least one type of use to the user for the at least one determined equivalent source content item.

10. A method for managing the use of content over a network, comprising:
storing at least one of a source digital fingerprint or a source identifier that corresponds to each of a plurality of items of source content;
determining if an identifier included with an item of content of a user has an affirmative correspondence to at least one of the stored source identifiers associated with each source content item;
if the determination of the identifier of the item of content of the user is negative, determining if a digital fingerprint for the item of content of the user is substantially similar to at least one of the source digital fingerprints associated with the items of source content;
determining each licensed use that corresponds to the item of content of the user based on the affirmative correspondence between at least one of the source identifiers and the identifier of the item of content of the user or a substantially similar comparison between the source digital fingerprints and the digital fingerprint of the item of content of the user; and
if a license for the indicated use for the item of content of the user is determined to be unavailable, determining at least one other item of source content that is non-identical to the item of content of the user and that is substantially equivalent to the item of content of the user, wherein the determination of the at least one other item of source content is based on at least the affirmative correspondence.

11. The method of claim 10, wherein at least one use of a copy of each source content item is licensable.

12. The method of claim 11, wherein the identifier included with an item of content of a user includes an indication of at least one particular type of use by the user.

13. The method of claim 10, wherein the identifier included with an item of content of a user includes an indication of at least one particular type of use by the user.

14. The method of claim 13, wherein the other item of source content is both substantially equivalent to the item of content of the user and available for licensing for the type of use indicated by the indicator of the item of content of the user.

15. The method of claim 12, wherein the other item of source content is both substantially equivalent to the item of content of the user and available for licensing for the type of use indicated by the indicator of the item of content of the user.

16. The method of claim 14, wherein determining each licensed includes determining each license previously provided for a user that corresponds to the received content item.

17. A method for managing the use of content over a network, comprising:
storing at least one of a source digital fingerprint or a source identifier that corresponds to each of a plurality of items of source content;
determining if an identifier included with an item of content of a user has an affirmative correspondence to at least one of the stored source identifiers associated with each source content item, wherein the identifier included with the item of content of the user includes an indication of at least one type of use by the user;
if the determination of the identifier of the item of content of the user is negative, determining if a digital fingerprint for the item of content of the user is substantially similar to at least one of the source digital fingerprints associated with the items of source content;
determining each licensed use that corresponds to the item of content of the user based on the affirmative correspondence between at least one of the source identifiers and the identifier of the item of content of the user or a substantially similar comparison between the source digital fingerprints and the digital fingerprint of the item of content of the user; and
if a license for the at least one indicated type of use for the item of content of the user is determined to be unavailable, determining at least one other item of source content that is non-identical to the item of content of the user and that is both substantially equivalent to such item of content and available for licensing to the user for the type of use indicated by the indicator of the item of content of the user, wherein the determination of the at least one other item of source content is based on at least the affirmative correspondence.

18. A system for managing the use of content over a network, the system comprising:
a processor; and
a memory including executable modules suitable for execution by the processor; wherein the system, via execution of one or more executable modules, is configured to:
determine if an identifier included with an item of content of a user has an affirmative correspondence to at least one of the stored source identifiers associated with each source content item, wherein the identifier included with the item of content of the user includes an indication of at least one type of use by the user;
if the determination of the identifier of the item of content of the user is negative, determine if a digital fingerprint for the item of content of the user is substantially similar to at least one of the source digital fingerprints associated with the items of source content;
determine each licensed use that corresponds to the item of content of the user based on the affirmative correspondence between at least one of the source identifiers and the identifier of the item of content of the user or a substantially similar comparison between the source digital fingerprints and the digital fingerprint of the item of content of the user; and
if a license for the at least one indicated type of use for the item of content of the user is determined to be unavailable, determine at least one other item of source content that is non-identical to the item of content of the user and that is both substantially equivalent to such item of content and available for licensing to the user for the type of use indicated by the indicator of the item of content of the user, wherein the determination of the at least one other item of source content is based on at least the affirmative correspondence.

19. A computer-readable medium bearing computer-executable instructions which, when executed on a computing device having a processor and a memory, configure the computing device to carry out a method for managing the use of content over a network according to claim 17.

20. A computer-readable medium bearing computer-executable instructions which, when executed on a computing device having a processor and a memory, configure the computing device to carry out a method for managing the use of content over a network according to claim 10.
